(19) United States
(12) Patent Application Publication
(10) Pub. No.: US 2014/0372272 A1
(43) Pub. Date: Dec. 18, 2014

(54) Lack of Liquidity Order Type

(71) Applicant: Chicago Mercantile Exchange, Inc., Chicago, IL (US)

(72) Inventors: John Labuszewski, Westmont, IL (US); Richard Co, Chicago, IL (US); John Nyhoff, Darien, IL (US); Lori Aldinger, Naperville, IL (US); James Boudreault, Palatine, IL (US)

(21) Appl. No.: 13/918,297

(22) Filed: Jun. 14, 2013

(51) Int. Cl. G06Q 40/04

(52) U.S. Cl. CPC G06Q 40/04
USPC 705/37

(57) ABSTRACT

Systems and methods are provided for matching orders. Orders are initially received at a central limit order book system. If an order remains unmatched or a portion of the order remains unmatched after a predetermined time period, order information is sent to a request for quote system. The request for quote system distributes a request for quote and provides any quotes to the original trading entity. An order may be matched at the central limit order book system or the request for quote system.

### FIELD OF THE INVENTION

The present invention relates to financial product trading systems and, in particular, to methods and systems that process orders for financial instruments.

### DESCRIPTION OF THE RELATED ART

Financial instruments, such as equity securities and derivative contracts, are typically traded by traders submitting orders to a central limit order book. It is common for market makers to contribute liquidity to markets for less frequently traded financial instruments so that traders always have an opportunity to buy and sell financial instruments. Less liquid markets subject traders to various risks. Risk may include various execution risks such as partial execution and slippage.

Request for quote systems are commonly used for trading option and options on futures contracts when liquid markets are not available. Option contracts are based on underlying financial instruments. For each underlying financial instrument, there may be numerous put and call option contracts available with a variety of expiration months and a variety of strike prices. Option trading strategies many times include combining numerous option contracts. Because of the number of combinations available, it becomes impractical for market makers or others to create continuously-quoted markets for all of the different types of option strategies. It is common for option traders to create request for quote messages that identify option contracts that a trader desires to trade and requests that market makers or other entities provide a quote or price. Option traders review quotes that they receive and then decide whether to trade and with whom to trade. Request for quote systems are considered a component of central limit order book trading by U.S. regulators, and thereby encouraged versus other means of off exchange trading. There are concerns that alternatives to request for quote systems, such as off-exchange trades or block trades, are not transparent and divert liquidity from central limit order books.

Therefore, there is a need in the art for improved request for quote systems and methods for trading financial products allow traders to trade financial instruments when liquid markets are not available.

### SUMMARY OF THE INVENTION

Embodiments of the present invention overcomes problems and limitations of the prior art by providing systems and methods for matching orders that include a central limit order book system and an enhanced request for quote system. In one embodiment, orders are initially received at a central limit order book system. The central limit order book system attempts to match the order and if the order remains unmatched after a predetermined time period, order information is automatically sent to a request for quote system. The request for quote system distributes a request for quote and provides any quotes supplied back to the original trading entity. An order may be matched at the central limit order book system or the request for quote system.

In other embodiments, embodiments of the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims. Brief

### DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention;

FIG. 2 illustrates a system that may be used to process orders for financial instruments in accordance with an embodiment of the invention; and

FIG. 3 illustrates a method of processing orders for financial instruments, in accordance with an embodiment of the invention.

### DETAILED DESCRIPTION OF THE INVENTION

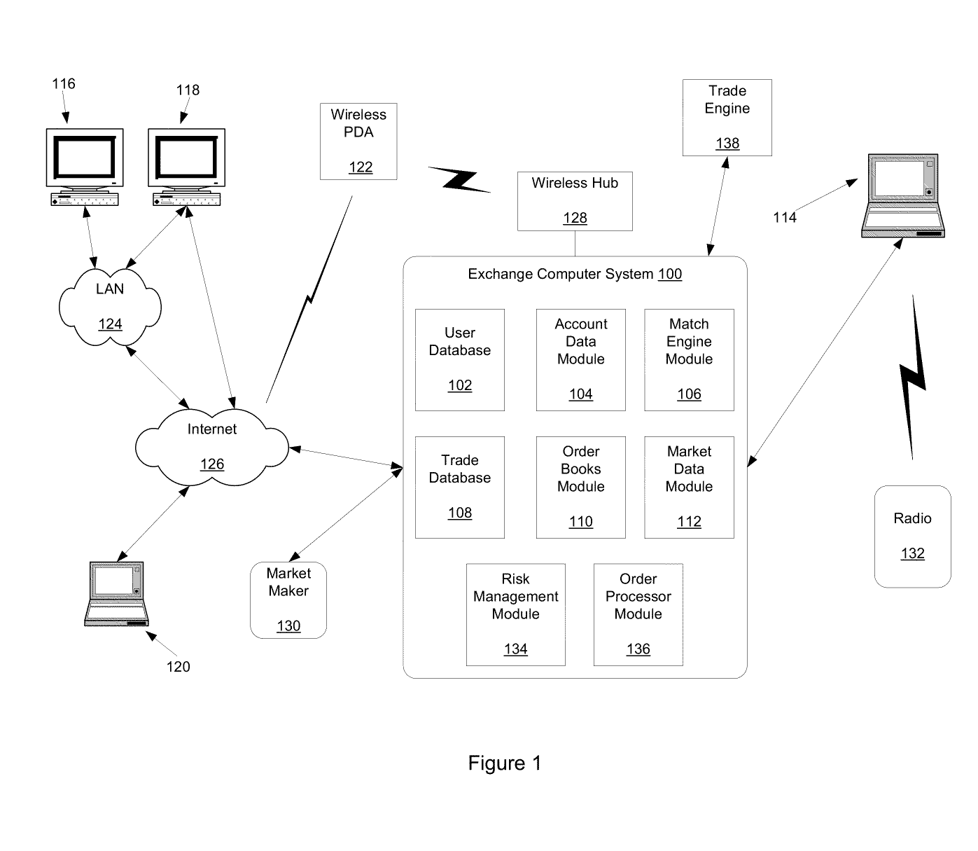

Aspects of the present invention may be implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords potentially with other information to identify users uniquely or collectively. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processor module 136 may be included to decompose variable defined derivative product and aggregate order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems. Coupling can be direct as described or any other method described herein.

The operations of computer devices and systems shown in FIG. 1 may be controlled by computer-executable instructions stored on a computer-readable medium. Various computer-readable media that are tangible and non-transitory may be used. In one example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

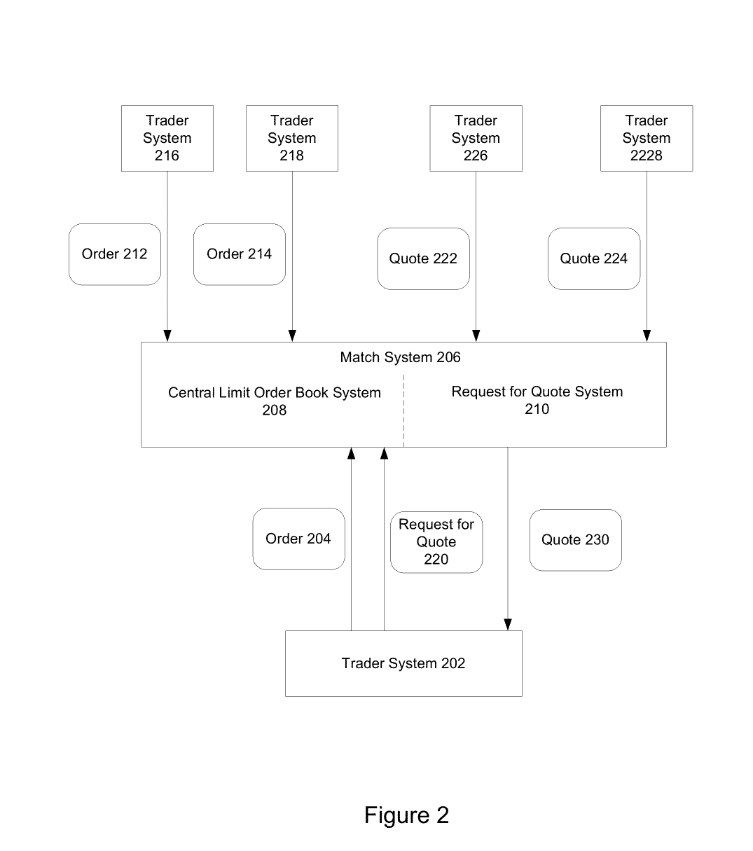

FIG. 2 illustrates a system that may be used to process orders for financial instruments in accordance with an embodiment of the invention. A trader system 202 is configured to submit an order 204 to a match system 206. Trader system 202 may be implemented with a programmed computer device, such as one of the computer devices described above. Match system 206 includes a central limit order book system 208 and a request for quote system 210 and may be implemented with one or more programmed computer devices.

Central limit order book system 208 may receive and orders, such as orders 212 and 214 from trader systems 216 and 218 and match orders. For example, order 204 may be an order to buy a financial instrument at a specific price and order 212 may be an order to sell the financial instrument at the same price. In this example, central limit order book 208 may be programmed to match orders 204 and 212.

Request for quote system 210 may receive requests for quotes, publish or otherwise distribute the requests and provide any quotes to a trading entity. In one implementation trader system 202 submits a request for quote 220 to request for quote system 210. The request may be for an option strategy that includes a plurality of options contracts or for some other financial instrument. The request may also include buying some financial instruments and selling other financial instruments. Request for quote system 210 may publish the request and receive quotes 222 and 224 from trader systems 226 and 228, respectively. Quotes 222 and 224 include price levels at which traders 226 and 228 are willing to enter into the transaction identified in request for quote 220. Request for quote system 210 provides quotes 230 to trader system 202. Trader system 202 may determine if any of the quotes are priced at a level at which it is desirable to enter into the transaction.

Match system 206 may be configured or programmed to link central limit order book system 208 and request for quote system 210. In one embodiment match system 206 may identify one or more orders that have remained pending at central limit order book system 208 for a predetermined period of time and provide an identification of the financial instruments to request for quote system 210. Request for quote system 210 may publish or otherwise distribute a corresponding request for quote to trading entities. In some embodiments match system 206 may cancel the original order pending at central limit order book system 208 as soon as request for quote system 210 publishes the corresponding request for quote. In other embodiments, central limit order book system 208 and request for quote system 210 may be configured to cancel orders and requests at the other system as soon as one of the systems executes an order. Match system 206 may also be programmed or configured to monitor central limit order book system 208 and request for quote system 210 and cancel orders and requests when appropriate.

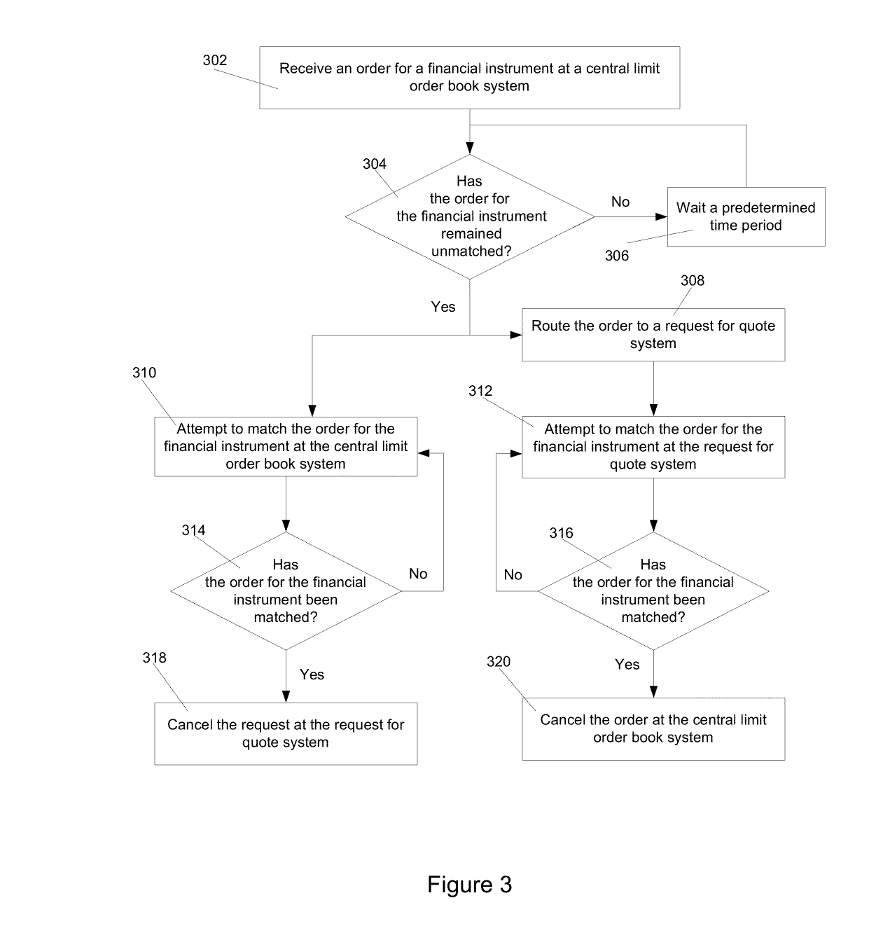

FIG. 3 illustrates a method of processing orders for financial instruments, in accordance with an embodiment of the invention. First, in step 302 an order for a financial instrument is received at a central limit order book system. The central limit order book system may be similar to central limit order book system 208 shown in FIG. 2. The order may be for equities, options, futures, other types of derivatives, combinations and other types of financial instruments. In one example the order is for a combination of option contracts. In step 304 it is determined whether the order for the financial instrument has remained unmatched. Step 304 may include determining if the order for the financial instrument is unmatched within a predetermined time period. The time period may be 15 seconds, 30 seconds, 1 minute, 5 minutes, 60 minutes or any other time selected by an operator of a match system. Step 304 may also include determining if the order is on the market or within a predetermined number of tick levels of a best bid or best offer. The on the market requirement prevents bids and offers farther away from the best bid and offer process from taking advantage of the steps described below. In an alternative embodiment, step 304 may include determining if a predetermined percentage of the order is unmatched within a predetermined time period. The percentage may be 50%, 60%, 70% or any other percentage selected by an operator of a match system.

When the order has not remained unmatched, in step 306 the process waits a predetermined period before returning to step 304. When the order has remained unmatched, the order is sent to a request for quote system, such as request for quote system 210, in step 308. Step 308 may include sending the actual order or any amount of information necessary to create a request for quote.

FIG. 3 illustrates a process in which a central limit order book system and a request for quote system simultaneously attempt to match the order. In particular, in step 310 a central limit order book system attempts to match the order for the financial instrument while a request for quote system attempts to match the order in step 312. Step 312 may include publishing or otherwise distributing a request for quote and providing any quotes to a trading entity as described above. In steps 314 and 316 it is determined if the order has been matched at the central limit order book system or the request for quote system, respectively. When the order has not been matched at the central limit order book system, the process returns to step 310. When the order has been matched at the central limit order book system, in step 318 the request for quote is canceled at the request for quote system. When the order has not been matched at the request for quote system, the process returns to step 312. When the order has been matched at the request for quote system, in step 320 the order at the central limit order book system is canceled.

While FIG. 3 illustrates a process in which a central limit order book system and a request for quote system simultaneously attempt to match the order, in other embodiments orders at the central limit order book may be canceled when the request for quote system publishes or otherwise distributes a request for quote.

The present invention has been described herein with reference to specific exemplary embodiments thereof. It will be apparent to those skilled in the art, that a person understanding this invention may conceive of changes or other embodiments or variations, which utilize the principles of this invention without departing from the broader spirit and scope of the invention as set forth in the appended claims. All are considered within the sphere, spirit, and scope of the invention.

What is claimed is:

1. A method of processing orders for financial instruments comprising:
(a) receiving an order for a financial instrument at a central limit order book system;
(b) determining at the central limit order book system if the order for the financial instrument is unmatched; and
(c) when it is determined that the order is unmatched in (b), routing the order to a request for quote system.

2. The method of claim 1, wherein (b) comprises determining if the order for the financial instrument is unmatched within a predetermined time period.

3. The method of claim 1, wherein (b) comprises determining if the order for the financial instrument is on the market matched and unmatched after a predetermined time period.

4. The method of claim 3, wherein the order for the financial instrument is on the market when a price of the order is within a predetermined number of tick levels of a best bid or best offer.

5. The method of claim 1, wherein (b) comprises determining if a predetermined portion of the order for the financial instrument is unmatched within a predetermined time period.

6. The method of claim 1, further including:
(d) canceling the order for the financial instrument at the central limit order book system.

7. The method of claim 1, further comprising:
(d) simultaneously attempting to match the order for the financial instrument at the central limit order book system and the request for quote system.

8. The method of claim 7, further comprising:
(e) when the financial instrument is matched at one of the central limit order book system or the request for quote system, canceling an order at the other of the central limit order book system or the request for quote system.

9. The method of claim 1, wherein the order for a financial instrument comprises an order for at least one derivative product financial instrument.

10. The method of claim 1, wherein the order for a financial instrument comprises an order for a plurality of option contracts.

11. A financial instrument trading system comprising:
a request for quote system;
a central limit order book system configured to:
(a) receive an order for a financial instrument;
(b) determine if the order for the financial instrument is unmatched; and
(c) when it is determined that the order is unmatched in (b), routing the order to the request for quote system.

12. The financial instrument trading system of claim 11, wherein (b) comprises determining if the order for the financial instrument is unmatched within a predetermined time period.

13. The financial instrument trading system of claim 11, wherein (b) comprises determining if the order for the financial instrument is on the market matched and unmatched after a predetermined time period.

14. The financial instrument trading system of claim 13, wherein the order for the financial instrument is on the market when a price of the order is within a predetermined number of tick levels of a best bid or best offer.

15. The financial instrument trading system of claim 11, wherein (b) comprises determining if a predetermined portion of the order for the financial instrument is unmatched within a predetermined time period.

16. The financial instrument trading system of claim 11, wherein the order for a financial instrument comprises an order for at least one derivative product financial instrument.

17. The financial instrument trading system of claim 11, wherein the order for a financial instrument comprises an order for a plurality of option contracts.

18. A non-transitory computer-readable medium containing computer-executable instructions that when executed cause an exchange computer system to perform the steps comprising:
(a) receiving an order for a financial instrument at a central limit order book system;
(b) determining if the order for the financial instrument is unmatched; and
(c) when it is determined that the order is unmatched in (b), routing the order to a request for quote system.

19. The non-transitory computer-readable medium of claim 18, wherein (b) comprises determining if the order for the financial instrument is unmatched within a predetermined time period.

20. The non-transitory computer-readable medium of claim 18, wherein the order for a financial instrument comprises an order for a plurality of option contracts.

21. The non-transitory computer-readable medium of claim 18, wherein the computer-executable instructions when executed further cause the exchange computer system to perform the step comprising:
(d) creating a request for quote from the central limit order book order.
